(19) United States
(12) Patent Application Publication
(10) Pub. No.: US 2016/0008996 A1
(43) Pub. Date: Jan. 14, 2016

(54) LIGHTED FIBER OPTIC SCRIBING TOOL

(71) Applicant: Jonathan Michael Dunn, Fayetteville, NC (US)

(72) Inventor: Jonathan Michael Dunn, Fayetteville, NC (US)

(21) Appl. No.: 14/330,407

(22) Filed: Jul. 14, 2014

(51) Int. Cl. B26D 3/08

(52) U.S. Cl. CPC B26D 3/08

(57) ABSTRACT

There is provided a fiber optic scribing tool having a self-contained internal light source. The internal light source is coupled via one or more optical fibers to a rear edge of a transparent or translucent scribing blade removably inserted in a chuck of the illuminated fiber optic scribing tool. Typically an LED light source is used. An internal power source is disposed within a chuck receiver, for example one or more disposable or rechargeable batteries. If rechargeable batteries are selected, a connector is provided on an external surface of the scribing tool to allow the internal battery(s) to be recharged. A switch is provided to selectively turn the light source on and off. In alternate configurations, a clip-on external light source is provided for adding to an existing prior art fiber optic scribing tool. In another embodiment, a stop is positioned on a lower surface of the scribing blade.

### RELATED APPLICATIONS

This application claims priority in accordance with 37 C.F.R. ¶1.19(e) to U.S. Provisional Patent Application Ser. No. 61/889,699 filed Oct. 13, 2013 for LIGHTED FIBER OPTIC SCRIBE TOOL which is included herein in its entirety by reference.

### FIELD OF THE INVENTION

The invention pertains to scribing tools and, more particularly to a hand held illuminated, scribing and breaking tool for optical fibers. Either an internal or an external illumination source may be provided.

### BACKGROUND OF THE INVENTION

The segments of optical fiber used in fiber optic systems are taken from long lengths of optical fiber. These segments must be cut from the longer lengths and then joined with other fiber optic devices, such as another segment of optical fiber or an electro-optic device. In order to maximize signal transmission across these interfaces, it is necessary that the ends of the segments be free of imperfections.

It is known that by scribing an optical fiber and inducing a tensile stress, the optical fiber will fracture at the scribe point. This leaves a fiber surface that has only slight imperfections, requiring minimal polishing to produce a defect-free surface. The scribe-and-break technique is especially useful for field work because it can be incorporated into a hand tool that produces a clean break at a determinable location without complex machinery. A scribe-and-break tool that will be used in the field must be user-friendly and rugged enough to withstand the inevitable mishandling.

It would, therefore, be advantageous to provide a fiber optic scribe tool having a self-contained light source.

### DISCUSSION OF THE RELATED ART

Several attempts to provide suitable tools for scribing and/or breaking optical fibers may be found in the prior art. For example, U.S. Pat. No. 4,322,025 for TOOL FOR CUTTING OPTICAL FIBERS issued Mar. 30, 1982 to Erlon F. Johnson discloses a scribe-and-break hand tool having a scribe fixed to a frame opposite an arcuatly shaped fiber supporting surface that is displaceable towards the scribe. The optical fiber is placed on the arcuate surface where it is held in place by spring members. As the arcuate surface is moved towards the scribe, the spring members form the fiber along the arcuate surface, thereby instilling a tensile stress into the optical fiber. The fiber fractures and breaks when the scribe contacts the fiber.

U.S. Pat. No. 4,611,400 for BLADE AND PROCESS OF MAKING SAME, issued Sep. 16, 1986 to Anthony F. Drake teaches a single or multi-edge blade including a fractured edge. The blade can be oriented to be left-handed, right-handed, or two-sided. The size, shape and sharpness of the blade are a function of controlled variables during fracturing. The sharpness of the blade occurs along and at a molecular level in a controlled process, dependent upon the material and the predetermined variables of fracturing. The blade can consist of glass, crystalline, non-crystalline, and composite or like materials.

U.S. Pat. No. 5,063,672 for HAND-HELD TOOL FOR SCORING AND SEVERING AN OPTICAL FIBER, issued Nov. 12, 1991 to Igor Grois et al. discloses another scribe-and-break hand tool that has a scoring probe that is reciprocally moveable within a generally hollow body in response to actuation of a trigger mechanism upon the body. The body itself supports and positions the fiber and the scoring probe moves to contact with the fiber at discrete angles over a defined area with predetermined force during a specific time interval. In one embodiment, an illuminated scalpel is provided.

U.S. Pat. No. 5,816,128 for SEVERING DEVICE, issued Oct. 6, 1998 to Andrew Bruce Walter Bigley, Jr. et al. discloses a device for severing flexible polymeric tube, pipe, or tubular extrudate, such as flexible light pipe, reproducibly, cleanly, and safely is described. The device comprises a block with two specially aligned cylindrical devices for holding the pipe and a slot between the devices for guiding the severing blade with minimum deviation from its path, and a pivot and mounting upon which a blade in a holder is mounted to give even more accurate and uniform control of the path of the severing action.

U.S. Pat. No. 5,908,433 for CARPAL TUNNEL KNIFE, issued Jun. 1, 1999 to Kris D. Eager et al. discloses a surgical knife for carpal tunnel surgeries having a housing with an adjacent light source and a light transmitting blade holder transmitting the light from the housing around the blade. The light illuminates the surgical site and assists the surgeon in precisely locating the cutting blade.

U.S. Pat. No. 6,024,004 for FIBER OPTIC TERMINATOR TOOL, issued Feb. 15, 2000 to Joseph P. Kosiarski et al. teaches a terminating tool for scribing a cleavage line on an optical fiber, which is made of a brittle material, the tool holds the fiber in two locations. A connector for the outer sleeve covering the fiber is supported at one location, and the other support includes a bar that compresses the fiber against an anvil through a resilient material. A scribing disc is mounted on a flexible arm and is slid transverse the fiber at a location so the disc engages a portion of the fiber periphery as the flexible arm deflects to permit the disc to move transversely to the fiber. A slide mounts the flexible arm carrying the disc, and the slide is moved through a second flexible link to reduce the transmission of unwanted motions to the slide, so that an accurate scribe line can be made on the fiber.

United States Published Patent Application No. 2010/0069722 for INTUBATION LARYNGOSCOPE WITH DETACHABLE BLADES, published Mar. 18, 2010 upon application by Michael Shalman et al. discloses an intubation laryngoscope having reusable and disposable blades adapted for both right and left-handed operation, an illumination system mounted on the laryngoscope handle, and an improved fastening appliance for detachable connection of the blades to the laryngoscope handle.

European Patent Application No. EP0306461 A1 for TOOL HAVING A BUILT-IN LIGHT SOURCE, published Mar. 8, 1989 upon application by Jan Lennart Tuvesson discloses a tool such as a knife having a built-in light generating unit.

Japanese Patent Application No. JP404266752A published Sep. 22, 1992 upon application by Siegfried Riek et al. discloses a tissue piercing instrument equipped with a hollow shaft having a pointed end forming a conical window. An optical lens equipped with an illumination device for the pointed end is passed through the hollow cylinder shaft until it reaches the clearance of a main spindle behind the apex of the pointed end. Therefore, the instrument can be made to pierce while viewing the piercing part.

None of the patents and published patent applications, taken singly, or in any combination are seen to teach or suggest the illuminated scribing tool of the invention.

### SUMMARY OF THE INVENTION

In accordance with the present invention there is provided a fiber optic scribing tool having an internal light source. The internal light source is coupled via one or more optical fibers to a rear edge of a transparent or translucent scribing blade removably inserted in a chuck of the illuminated scribing tool. Typically an LED light source is used. An internal power source is disposed within a chuck receiver, for example one or more disposable or rechargeable batteries. If rechargeable batteries are selected, a connector is provided on an external surface of the scribing tool to allow the internal battery(s) to be recharged. A switch is provided to selectively turn the light source on and off.

In alternate embodiments, a clip-on external light source is provided for adding to an existing prior art fiber optic scribing tool.

Numerous other advantages and features of the present invention will be become readily apparent from the following detailed description of the invention and the embodiments thereof, from the claims and from the accompanying drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1A is a side elevational, cross-sectional, exploded, schematic view of a fiber optic scribe of the prior art;

FIG. 1B is a side elevational, cross-sectional, schematic view of the a fiber optic scribe of the prior art of FIG. 1A with the components partially assembled;

FIG. 1C is a side elevational, schematic view the a fiber optic scribe of the prior art of FIGS. 1A and 1B with the components completely assembled;

FIG. 2A is a side elevational, cross-sectional, exploded, schematic view of an internally illuminated fiber optic scribe in accordance with the invention;

FIG. 2B is a side elevational, cross-sectional, schematic view of the a illuminated fiber optic scribe of FIG. 2A with the components partially assembled;

FIG. 2C is a side elevational, schematic view of the internally illuminated fiber optic scribe of the prior art of FIGS. 2A and 2B with the components completely assembled;

FIG. 3 is a side elevational schematic view of the fiber optic scribe of FIG. 1 having an external light source attached thereto in accordance with the invention;

FIG. 4 is a front elevational view of the external light source of FIG. 3; and

FIG. 5 is a front elevational, schematic view of an alternate cutting/scribing blade having a stop attached thereto.

### DETAILED DESCRIPTION OF THE PREFERRED EMBODIMENT

The present invention provides scribe for an optical fiber using a transparent or translucent, chamfered blade and an illumination source. The illumination source may be housed within the scribe body or, alternately the illumination source may be external to the scribe body.

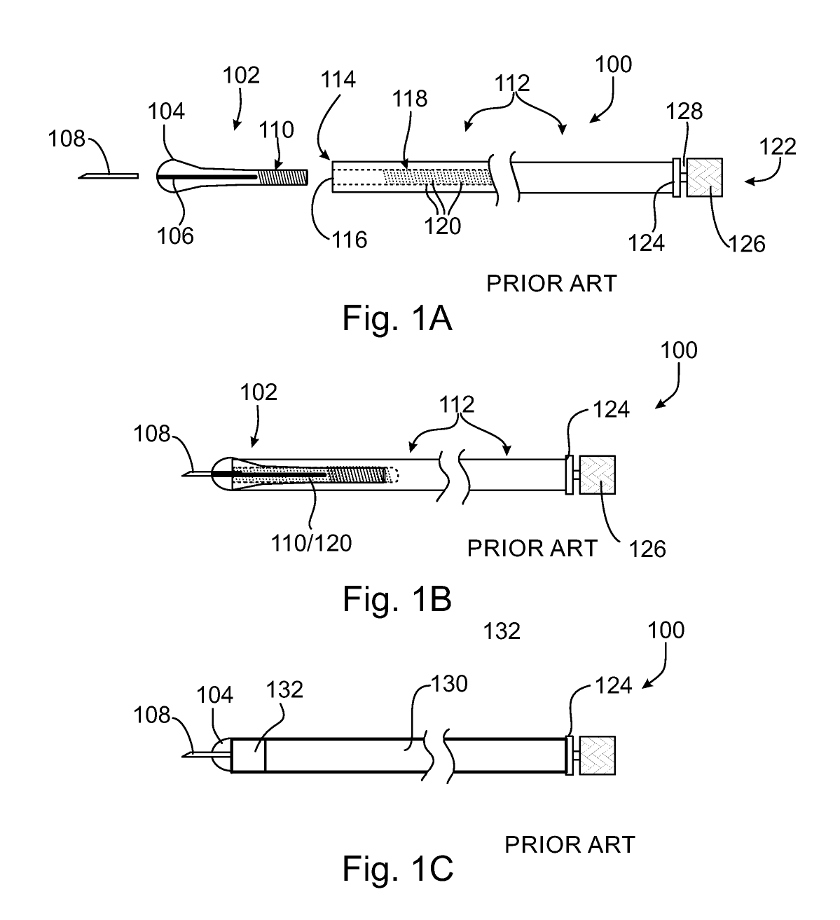

Referring first to FIG. 1A, there is shown a side cross-sectional, exploded, schematic view of a fiber optic scribe of the prior art, generally at reference number 100.

Prior art fiber optic scribe 100 has a chuck 102 having a bulbous head 104. Bulbous head 104 has a longitudinal split 106 sized and configured to receive and retain a distal portion of a flat blade 108. Typically, a second split, not visible in FIG. 1A is disposed parallel to split 106 and normal thereto. A distal portion of chuck 102 carries external threads 110. This arrangement is similar to the collet chuck believed to be well known to those of skill in the art.

An elongated, cylindrical chuck receiver 112 has a circular opening 116 in a proximal end 114 thereof. Circular opening 116 provided access to an interior region 118 of chuck receiver 112. Interior region 118 is provided with internal threads 120 adapted for engagement and retention of external threads 110 of chuck 102.

The distal end of chuck receiver 112 has a shoulder 124 and a knurled knob 126 rearward thereof. Knurled knob 126 may be separated from shoulder 124 by a space 128.

It will be noted that the portion of chuck 102 bearing threads 110 is solid, at least rearward of the terminus, not specifically identified, of slot 106.

Referring now also to FIG. 1B, there is shown a side elevational, cross-sectional, schematic view of the blade 108, chuck 102, and chuck receiver 112 assembled. Threads 110 of chuck 102 are screwed into internal threads 120 of chuck receiver 112. The screwing threads 110 of chuck 102 into internal threads 120 squeezes slot 106 and causes the surfaces, not specifically identified, of slot 106 to tightly grip and retain blade 108 therein.

Referring now also to FIG. 1C, there is shown a side elevational, schematic view of a completely assembled fiber optic scribe 100. An outer cover 130 is disposed over the assembly of chuck 102 and chuck receiver 112.

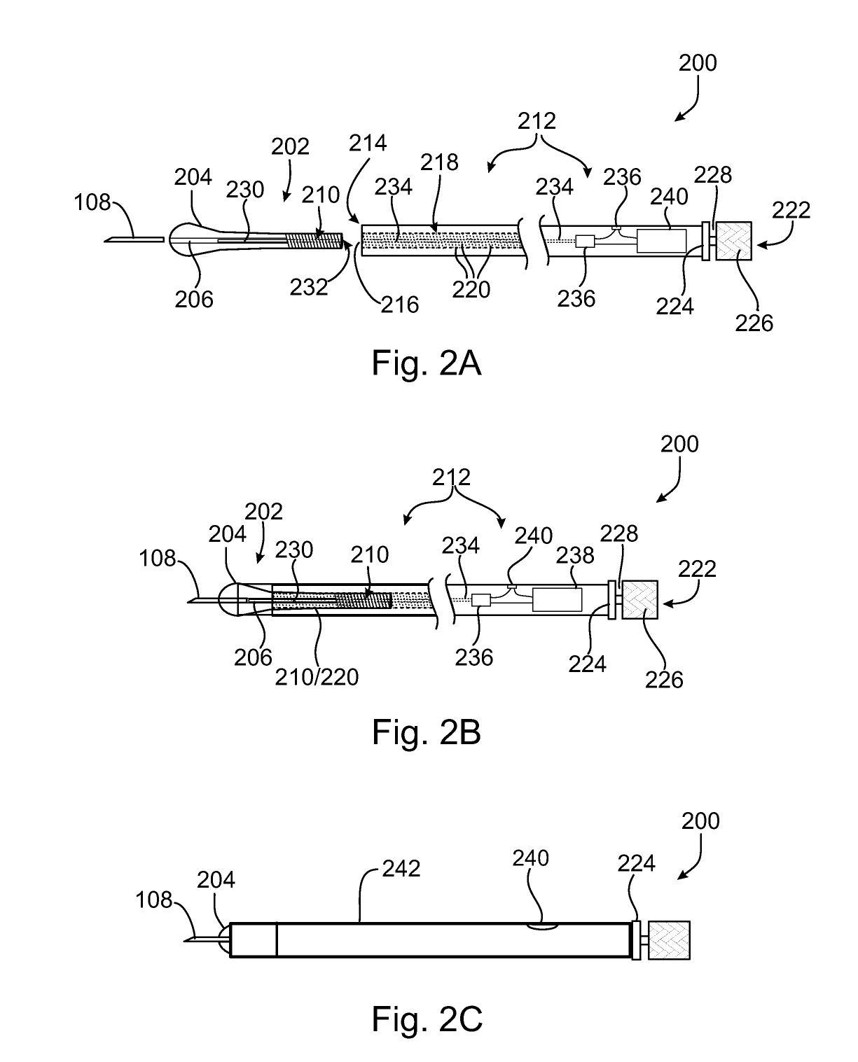

Referring now also to FIG. 2A, there is shown a side elevational, cross-sectional, exploded, schematic view of an internally illuminated fiber optic scribe in accordance with the invention, generally at reference number 200.

Internally illuminated fiber optic scribe 200 has a chuck 202 having a bulbous head 204. Bulbous head 204 has a longitudinal split 206 sized and configured to receive and retain a distal portion of a transparent or translucent flat blade 108. Typically, a second split, not visible in FIG. 2A is disposed parallel to split 206 and normal thereto. A distal portion of chuck 202 carries external threads 210 thereupon. A forward optical fiber 230 is disposed centrally in slot 206 and continuing longitudinally through chuck 202 to its distal end 232.

Referring now also to FIG. 2B, there is shown a side elevational, cross-sectional, schematic view of the blade 108, chuck 202, and chuck receiver 212 assembled (i.e., connected one to another). Threads 210 of chuck 202 are screwed into internal threads 220 of chuck receiver 212. Screwing threads 210 of chuck 202 into internal threads 220 squeezes slot 206 and causes the surfaces, not specifically identified, of slot 206 to tightly grip and retain blade 108 therein. However, unlike the structure of chuck 202 of the prior art, chuck 202 is completely hollow. A forward optical fiber 230 is centrally and longitudinally disposed in chuck 202. A proximal end of optical fiber 230 is positioned to be adjacent a distal end of flat blade 108. Forward optical fiber 230 runs rearward in chuck 202 terminating at the distal end 232 of chuck 202.

A rearward optical fiber 234 in chuck receiver 212 has a proximal end, not specifically identified, and is adapted to mate with a distal end, not specifically identified, of forward optical fiber 230 when chuck 202 is screwed into chuck receiver 212. Rearward optical fiber 234 terminates at a light source 236. Light source 236 is connected to a power source 238 through an intervening switch 240.

Referring now also to FIG. 2C, there is shown a side elevational, schematic view of a completely assembled internally illuminated fiber optic scribe 200. An outer cover 242 is disposed over the assembly of chuck 202 and chuck receiver 212.

Light source may be any compact light source known to those of skill in the art. For purposes of disclosure, an LED light source is assumed. However, the patent is not intended to be limited to the LED light source used for purposes of disclosure. Rather, the patent is intended to include any and all equivalent light sources.

It will be further recognized that numerous types of switch may be used to implement switch 240. For purpose of disclosure switch 240 is implemented as a push button (I.e., a well-known push on/push off switch) disposed in a side wall of chuck receiver 212 and cover 242. Other types of switched and/or switch locations are also believed to be well known to those of skill in the art and any suitable switch type and/or switch location may be substituted for the push on/push off switch located in a side wall chosen for purposes of disclosure.

Power source 238 may be a cylindrical battery, either rechargeable or disposable disposed in a central bore of chuck receiver 212. If a disposable battery is chosen, means for opening a rear portion of chuck receiver 212, not shown, to provide access to the disposable battery forming power supply 238 thereby allowing replacement thereof as necessary. As such mechanisms are believed to be well known to those of skill in the art, consequently they are neither further discussed nor described herein.

If a rechargeable battery is chosen as power source 238, a connector, not shown, may be provided to allow connection of the internal rechargeable battery forming power source 238 to a recharger, not shown. Such connectors, support circuitry, and rechargers themselves are believed to be well known and, consequently, are neither further described nor discussed herein.

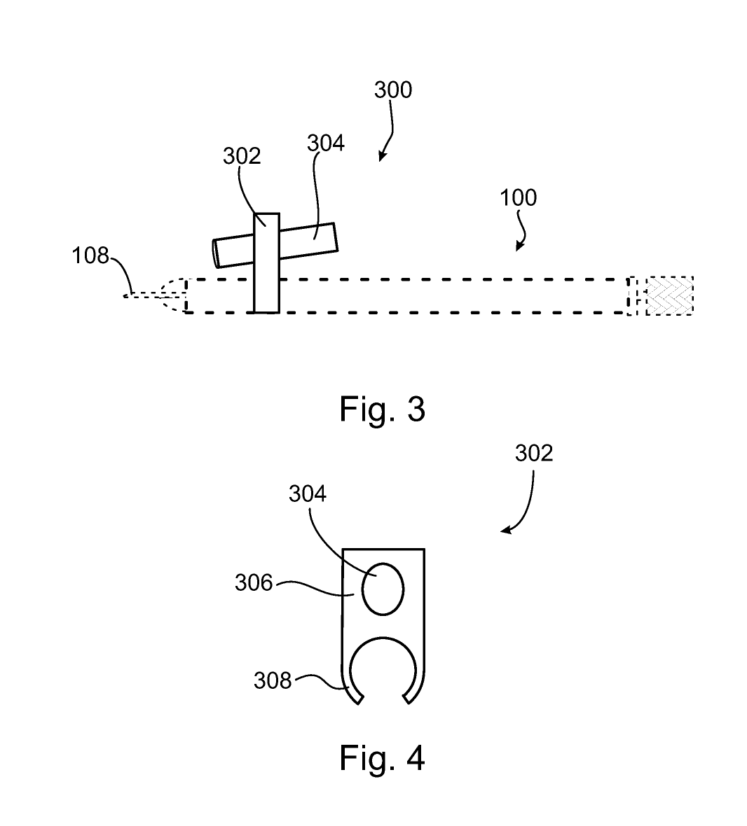

Referring now also to FIG. 3, there is shown a fiber optic scribe 100 of the prior art having an external light source 300 removably attached thereto. Light source 300 consists of a clip-on holder 302 for a cylindrical light source 304. Light source 304 is typically disposed at an angle so as to focus a light beam therefrom at a work site where a fiber optical strand is to be scribed.

Referring now also to FIG. 4, there is shown a front elevational, schematic view of clip-on holder 302. Clip-on holder 302 comprises a body 306 having a resilient clip portion 308 disposed at a lower edge, not specifically identified. Light source 304 is retained in an upper portion of clip-holder 302.

Light source 304 is typically a cylindrical LED “flashlight” or “penlight” having one or more batteries contained within a body thereof. Such flashlights or penlights are considered to be well known and widely available commercially. Consequently, the specifics of light source 304 are not discussed in more detail herein.

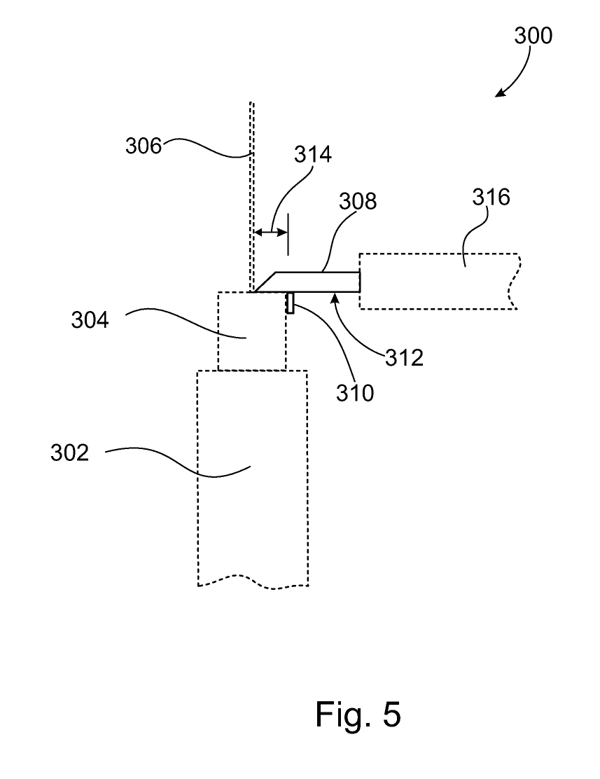

Referring now also to FIG. 5, there is shown a front elevational, schematic view of a novel cutting/scribing blade 308 having a stop 310 affixed to a lower surface, not specifically identified.

A bare optical fiber 306 is terminated in a fiber housing 302 typically providing an anaerobic style fiber termination and terminating in a ferrule 304. A bare optical fiber 306 protrudes beyond a distal end, not specifically identified, of ferrule 304,

A novel cutting/scribing blade 308 has a stop 310 disposed on a lower surface 312. A front surface, not specifically identified, of stop 310 is spaced apart from the nearest surface of the bare optical fiber 306 by a distance 314. Distance 314 is different for different optical fiber diameters and ferrule diameters.

In operation, stop 310 prevents a novice or an experienced technician but with a shaky hand from scoring raw optical fiber 306 too deeply.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A fiber optic scribing tool, comprising:
a) a cylindrical chuck assembly having a bulbous proximal end with a longitudinal slot disposed therein and external threads disposed on at least a portion of a distal end thereof, said chuck assembly having at least one optical fiber disposed longitudinally therethrough, said at least one optical fiber having a proximal end proximate said longitudinal slot and a distal end proximate a distal end of said chuck assembly;
b) an elongated chuck receiver having a proximal end having a central opening accessing a through bore centrally disposed in a proximal end thereof, said proximal bore having internal threads along a portion thereof;
c) a second group of at least one optical fiber extending from a point proximate said internal threads to a light source disposed within said chuck receiver;
d) a light source having a light output operatively connected to a distal end of said second group of at least one optical fiber;
e) a power source disposed within said chuck receiver proximate said light source and operatively connected thereto; and
f) an electrical switch interposed between said light source and said power source and configured to selectively connected and disconnect said power source to said light source.

2. The fiber optic scribing tool as recited in claim 1, wherein said power sources comprises at least one selected from the group: at least one disposable battery, and at least one rechargeable battery.

3. The fiber optic scribing tool as recited in claim 3, wherein when at least one rechargeable battery, said fiber optic scribing tool further comprises:
g) A connector on an outside surface of said fiber optic scribing tool, said connector being operatively connected to said at least one rechargeable battery.

4. The fiber optic scribing tool as recited in claim 1, wherein said light source comprises at least one LED light source.

5. A cutting/scribing blade for an optical fiber, the improvement comprising:
A downward depending stop affixed to a rear surface of the optical fiber cutting/scribing blade, said downward depending stop being positioned a predetermined distance from a tip of said cutting/scribing blade.
